(19) United States
(12) Patent Application Publication
(10) Pub. No.: US 2008/0258449 A1
(43) Pub. Date: Oct. 23, 2008

(54) RETENTION ARRANGEMENT FOR VEHICLE FRONT-END MODULE

(76) Inventors: Ronald Allen Wehner, Waterford, MI (US); Thomas Matthew Schlaf, Rochester Hills, MI (US); Paul Francis Dalka, Clarkston, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/736,038

(22) Filed: Apr. 17, 2007

(51) Int. Cl. B62D 21/12

(52) U.S. Cl. 280/785

(57) ABSTRACT

A vehicle includes a vehicle body defining at least one channel and a front-end module including at least one attachment arm having a retention feature movable between an extended position and a retracted position. The retention feature is movable into the retracted position when the at feast one attachment arm is inserted into the at least one channel and is biased into the extended position upon movement of the at least one attachment arm relative to the vehicle body a predetermined distance to prevent removal of the at least one attachment arm from the channel.

### FIELD OF THE INVENTION

The present invention relates to vehicle subassemblies and more particularly to a vehicle subassembly incorporating a retention feature.

BACKGROUND OF THE INVENTION

During vehicle manufacturing, it is common to assemble individual components into subassemblies prior to attaching the subassembly to a vehicle body to increase manufacturing efficiency and throughput. Such subassembly of individual components further increases manufacturing flexibility and reduces operational costs by allowing such subassemblies to be manufactured remotely from a vehicle-manufacturing facility.

While assembling individual components into subassemblies prior to attaching the subassembly to a vehicle body during manufacturing of the vehicle reduces manufacturing costs and improves manufacturing flexibility, attaching such subassemblies to a vehicle body typically requires multiple fasteners and/or fixtures to hold the subassemblies during attachment of the vehicle subassembly to the vehicle. Such fixtures are typically specific to the particular subassembly and, therefore, multiple fixtures are typically required for each respective subassembly to properly hold, locate, and position the subassembly relative to the vehicle when the subassembly is attached to the vehicle. The multiple fixtures result in an increase in tooling costs and therefore increase the overall complexity and cost of manufacturing the vehicle. Furthermore, while such fixtures are useful in positioning a vehicle subassembly relative to a vehicle, multiple operators are typically required to manipulate and position the fixture relative to the vehicle while concurrently driving fasteners to attach the vehicle subassembly to the vehicle.

### SUMMARY OF THE INVENTION

A front-end module for a vehicle includes at least one attachment arm matingly received by the vehicle and a retention feature associated with the at least one arm and movable between an extended position and a retracted position. The retention feature is biased into the extended position to attach the at least one attachment arm to the vehicle upon insertion of the at least one attachment arm into the vehicle.

A vehicle includes a vehicle body defining at least one channel and a front-end module including at least one attachment arm having a retention feature movable between an extended position and a retracted position. The retention feature is movable into the retracted position when the at least one attachment arm is inserted into the at least one channel and is biased into the extended position upon movement of the at least one attachment arm relative to the vehicle body a predetermined distance to prevent removal of the at least one attachment arm from the channel.

A method includes positioning a front-end module relative to a vehicle and moving the front-end module relative to the vehicle to align at least one attachment, arm of the front-end module relative to at least one channel of the vehicle. The method further includes inserting the at least one attachment arm into the at least one channel of the vehicle. A retention feature is deformed into a retracted position from an extended position by insertion of the at least one attachment arm into the at least one channel of the vehicle and at least one attachment arm is moved within the at least one channel a predetermined distance. The retention feature is moved from the retracted position into the extended position after the at least one attachment arm is moved the predetermined distance relative to the at least one channel of the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial perspective view of a vehicle incorporating a front-end module having a retention feature in accordance with the principles of the present invention;

FIG. 2 is a partial exploded view of the vehicle of FIG. 1 showing the front-end module removed from the vehicle;

FIGS. 3 is a perspective view of a retention feature for use with a vehicle subassembly; and

FIG. 4 is a perspective view of a retention feature for use with a vehicle subassembly.

### DETAILED DESCRIPTION OF THE PREFERRED EMBODIMENTS

The following description of the preferred embodiment(s) is merely exemplary in nature and is in no way intended to limit the invention, its application, or uses.

With reference to the figures, a subassembly 10 of a vehicle 12 is provided and includes a retention feature 14 that engages the vehicle 12 to attach the subassembly 10 to the vehicle 12. The retention feature 14 attaches the subassembly 10 to the vehicle 12 upon insertion of the subassembly 10 into the vehicle 12 and holds the subassembly 10 in a position relative to the vehicle 12 during attachment of the subassembly 10 to the vehicle 12.

The subassembly 10 may be a front-end module 16 including a carrier or housing 20 supporting the retention feature 14 and may include a series of support features 22 that support individual components of the vehicle 12. The housing 20 may be formed of a rigid material such as, for example, steel, and may include at least one attachment arm 24. The attachment arms 24 extend from the housing 20 and may include a tubular section defining an interstitial cavity 26.

The support features 22 of the housing 20 may be recessed from the housing 20 to such that pockets 28 are formed in the housing 20 and/or may include bracing 30 that extends from the housing 20, in either configuration, the pockets 28 and/or bracing 30 cooperate to support individual components of the vehicle 12. Such components may include a fascia 32, a bumper 34, a sensor assembly 36, a wire harness 38, a cooling module 39, and a lamp 40. The various components 32, 34, 36, 38, 39, 40 may be attached to the housing 20 at respective ones of the pockets 28 and bracing 30 such that the individual components 30, 32, 34, 36, 38, 39 are movable with the housing 20 once the components 30, 32, 34, 36, 38, 39, 40 are attached to the housing 20.

Attaching the individual components 30, 32, 34, 36, 38, 39, 40 to the housing 20 odor to attaching the housing 20 to the vehicle 12 improves the overall efficiency m manufacturing the vehicle 12. Individual components that require extensive manufacturing time may be preassembled to the housing 20, thereby allowing an assembly line in a vehicle manufacturing plant to maintain an increased speed and allowing more vehicles to be produced in a given time.

The retention feature 14 may be attached to at least one of the attachment arms 24 of the housing 20 to position the housing 20 relative to the vehicle 12 during assembly of the front-end module 16 to the vehicle 12. The retention feature 14 cooperates with the vehicle 12 to position the front-end module 16 relative to the vehicle 12 and also to hold the front-end module 16 in a desired position relative to the vehicle 12 prior to insertion of fasteners into the front-end module 16 and vehicle 12 to permanently attach the front-end module 16 to the vehicle 12.

The retention feature 14 may be attached at any location along a length of one or both of the attachment arms 24 and may include an arm 42 that is movable relative to the respective attachment arm 24 between an extended position and a retracted position. In one configuration, the arm 42 is pivotably attached to the respective attachment arm 24 and is biased into the extended position by a biasing member 44. The biasing member 44 may be any suitable biasing member such as, for example, a coil spring or leaf spring.

While the retention feature 14 is described as including an arm 42 pivotably attached to at least one of the attachment arms 24, the retention feature 14 could alternatively include a ball detent including a ball 46 movable between an extended position and a retracted position relative to the respective attachment arm 24. The ball 46 is biased into the extended position by a biasing member 48. The biasing member 48 may be any suitable biasing member that sufficiently urges the ball 46 into the extended position such as, for example, a coil spring or a leaf spring.

In yet another configuration, the retention feature 14 may be an elastically deformable arm 50 that may be integrally formed with respective ones of the attachment arms 24. For example, if the attachment arms 24 are formed from a pliable material such as, for example, plastic, the arms 50 may be moved between an extended position and a retracted position by applying a force to the arm 50 and moving the arm 50 from the extended position to the retracted position.

Movement of the arm 50 from the extended position to the retracted position is permitted without causing fracture of the arm 50 due to the generally elastic nature of plastic. If the attachment arms 24 are formed from a generally rigid material such as, for example, steel, the elastically deformable arm 50 may he formed from a plastic material, which may be fixedly attached at a predetermined location along a length of at least one of the attachment arms 24. In such a configuration, the arm 50 may be moved between an extended position and a retracted position relative to at least one of the attachment arms 24 in a similar fashion to an elastically deformable arm 50 that is integrally formed with the attachment arms 24, as described above.

The vehicle 12 may include structure 52 that matingly receives the attachment arms 24 of the front-end module 16 to support the front-end module 16 and individual components 32, 34, 36, 38, 39, 40 when the front-end module 16 is attached to the vehicle 12. The vehicle structure 52 may include at least one channel 54 respectively receiving the attachment arms 24 of the front-end module 15. The channels 54 may be individual components that are fixedly attached to the vehicle 12 or, alternatively, could be formed into a body 56 of the vehicle 12 if the vehicle 12 includes a uni-body construction. In any of the foregoing configurations, the channels 54 may each include at least one locking aperture 58 and at least one attachment aperture 60. The locking aperture 58 matingly and slidably receives the arm 42 of the retention feature 14 to position and hold the front-end module 16 relative to the vehicle 12. Once the front-end module 16 is positioned and held relative to the vehicle 12, fasteners 62 may be inserted into the attachment aperture 60 to fixedly and permanently attach the attachment arms 24 of the front-end module 16 to the structure 52 of the vehicle 12.

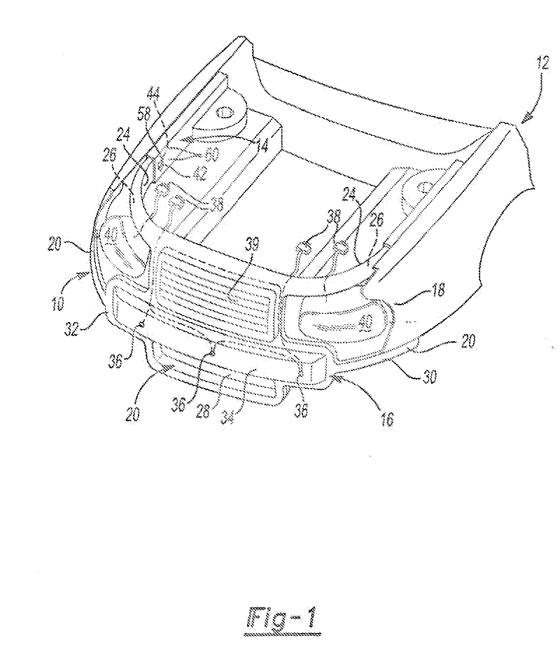

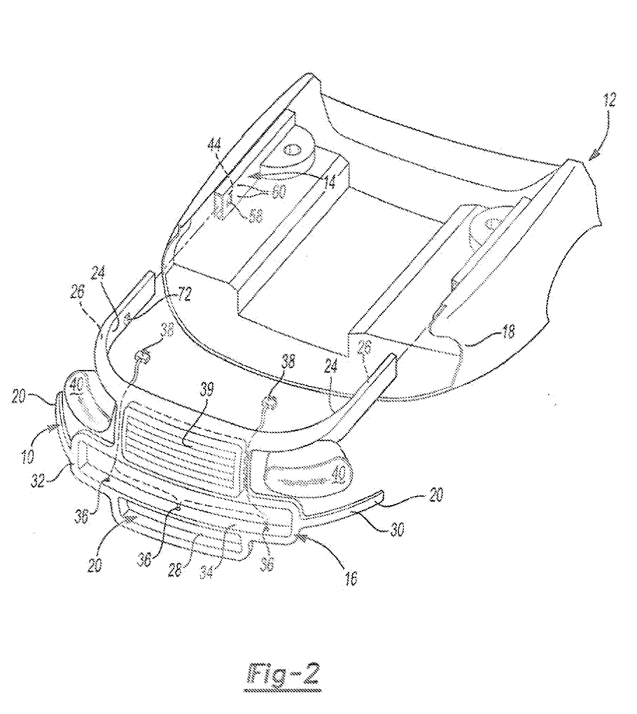

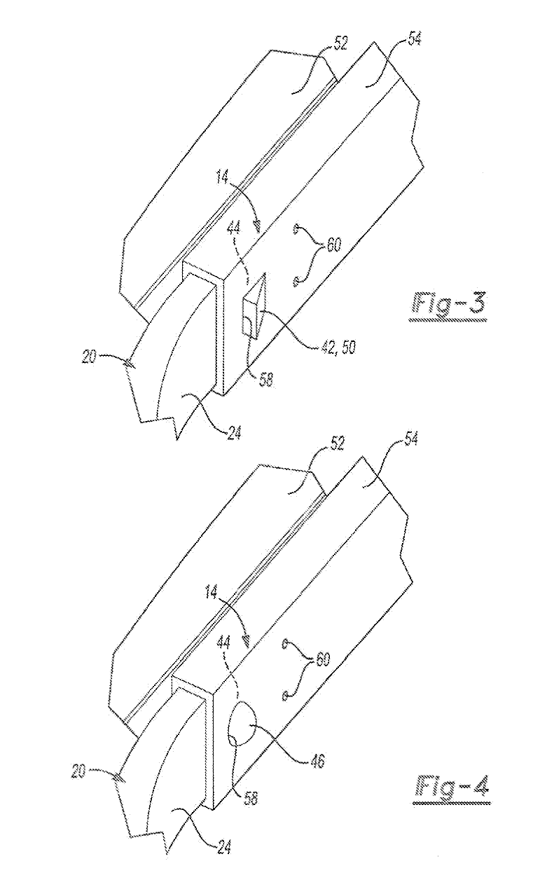

With particular reference to FIGS. 1 and 2, attachment of the front-end module 16 to the vehicle 12 will be described in detail. During assembly of the front-end module 16 to the vehicle 12, the front-end module 16 is positioned relative to the vehicle 12 using a fixture (not shown) that both carries and moves the front-end module 16 relative to the vehicle 12. The fixture moves the front-end module 16 and positions the attachment arms 24 relative to the channels 54 of the vehicle structure 52. Once the attachment arms 24 are positioned relative to the channels 54 of the vehicle 12, a force is exerted on the fixture and/or the front-end module 16 to move the front-end module 16 toward the vehicle 12.

Sufficient movement of the front-end module 16 relative to the vehicle 12 causes each attachment arm 24 to respectively engage and translate within channels 54 of the vehicle structure 52. Sufficient movement of the attachment arms 24 into the respective channels 54 causes the channels 54 to engage the arm 42 and move the arm 42 from the extended position to the retracted position and generally into the interstitial cavity 26 against the force imparted on the arm by the biasing member 44. While the retention feature 14 will be described hereinafter as including arm 42, attachment of the front-end module 16 using either the ball 46 or arm 50 configuration is virtually identical.

Once the arm 42 is moved into the retracted position from the extended position, the attachment arms 24 may be translated within the channels 54 relative to the vehicle 12. Upon sufficient translation of each attachment arm 24 within each channel 54, the respective arms 42 of the attachment arms 24 encounter respective locking apertures 58 of the channels 54. Movement of the attachment arms 24 relative to the channels 54 such that the arms 42 are aligned with the locking apertures 58 of the channels 54 allows the arms 42 to be biased from the refracted position into the extended position by the biasing member 44.

Movement of the arm 42 into the extended position and into the respective locking apertures 58 of the channels 54 restricts further movement of the attachment arms 24 relative to the channels 54 and, therefore, prevents further movement of the front-end module 16 relative to the vehicle 12. Therefore, engagement between the arms 42 and respective locking apertures 58 of the channels 54 both positions the front-end module 16 relative to the vehicle 12 and prevents removal of the front-end module 16 from the vehicle 12.

The arms 42 extend into the respective locking apertures 58 to properly position the front-end module 16 relative to the vehicle to facilitate insertion of the fasteners 62 into the respective attachment apertures 60 during permanent attachment of the attachment arms 24 to the vehicle structure 52. Because insertion of the fasteners 62 into the attachment aperture 60 of the channels 54 is a somewhat time-consuming process, interaction between the retention feature 14 and the channels 54 allows the front-end module 16 to he “temporarily” attached to the vehicle 12 prior to insertion of the “permanent” fasteners 62. Allowing the front-end module 16 to be “temporarily” attached to the vehicle 12 prior to insertion of the fasteners 62 improves the overall speed and efficiency with which the front-end module 16 is attached to the vehicle 12, as attaching each of the fasteners 62 to the attachment apertures 60, channels 54, and attachment arms 24 is not required to hold the front-end module 16 in proper position relative to the vehicle 12. Because the front-end module 16 is temporarily attached to the vehicle 12, each of the fasteners 62 are not required to be attached to the channels 54 and attachment arms 24 at the same station where the front-end module 16 is initially positioned and inserted into the vehicle 12. Therefore, the overall number of operations in positioning and inserting the front-end module 16 into the vehicle 12 are reduced at a single station and the process of attaching the fasteners 62 to the channels 54 and attachment arms 24 may be moved to another station along an assembly line. Such flexibility allows a vehicle manufacturer to properly balance each station along an assembly line and reduces the likelihood of a bottleneck occurring at any one station.

While the above process is described as including a fixture that properly positions and moves the front-end module 16 relative to the vehicle 12, the fixture is not specific to a particular vehicle or vehicle subassembly, as the fixture does not need to hold the front-end module 16 in a particular relationship relative to the vehicle 12 during installation of the fasteners 62. Rather, the fixture merely positions and moves the front-end module 16 relative to the vehicle 12, with the retention feature 14 properly positioning the front-end module 16 relative to the vehicle 12. Therefore, the fixtures used in holding and moving the front-end module 16 during assembly of the front-end module 16 to the vehicle 12 is not vehicle specific and may be used across vehicle platforms and years of manufacture.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A front-end module for a vehicle, the front-end module comprising:
at least one attachment arm matingly received by the vehicle; and
a retention feature associated with said at least one arm and movable between an extended position and a retracted position, said retention feature biased into said extended position to attach said at least one attachment arm to the vehicle upon insertion of said at least one attachment arm into the vehicle.

2. The front-end module of claim 1, wherein said retention feature includes at least one tab pivotably supported by said at least one arm.

3. The front-end module of claim 2, wherein said at least one tab is biased into said extended position by a spring.

4. The front-end module of claim 1, wherein said retention feature includes at least one detent ball matingly received by the vehicle when said at least one attachment arm is inserted into the vehicle.

5. The front-end module of claim 1, wherein said retention feature is integrally formed with said at least one attachment arm and elastically deforms into said retracted position when said at least one attachment arm is inserted into the vehicle and moves from said retracted position to said extended position when said at least one attachment arm is inserted a predetermined distance into the vehicle.

6. The front-end module of claim 1, wherein the vehicle includes at least one aperture matingly receiving said retention feature to prevent further movement of said at least one attachment arm relative to the vehicle when said at least one attachment arm is inserted into the vehicle.

7. The front-end module of claim 1, further comprising a housing attached to said at least one attachment arm and supporting at least one of a fascia, a bumper, a sensor, a wire harness, and a lamp.

8. A vehicle comprising:
a vehicle body defining at least one channel; and
a front-end module including at least one attachment arm having a retention feature movable between an extended position and a retracted position, said retention feature movable into said retracted position when said at least one attachment arm is inserted into said at least one channel and biased into said extended position upon movement of said at least one attachment arm relative to said vehicle body a predetermined distance to prevent removal of said at least one attachment arm from said channel.

9. The vehicle of claim 8, wherein said channel includes an aperture that matingly receives said retention feature when said at least one attachment arm is moved said predetermined distance relative to said channel and said retention feature is in said extended position.

10. The vehicle of claim 8, wherein said retention feature includes a tab pivotably supported by said at least one attachment arm between said extended position and said retracted position.

11. The vehicle of claim 10, wherein said tab is biased into said extended position by a spring.

12. The vehicle of claim 8, wherein said retention feature includes a detent ball.

13. The vehicle of claim 8, wherein said retention feature is integrally formed with said at least one attachment arm and is elastically deformed when moved from said extended position to said retracted position.

14. The vehicle of claim 8, wherein said front-end module includes a housing supporting at least one of a fascia, a bumper a sensor, a wire harness, and a lamp.

15. A method comprising:
positioning a front-end module relative to a vehicle;
moving said front-end module relative to said vehicle to align at least one attachment arm of said front-end module relative to at least one channel of said vehicle;
inserting said at least one attachment arm into said at least one channel of said vehicle;
deforming a retention feature into a retracted position from an extended position by insertion of said at least one attachment arm into said at least one channel of said vehicle;
moving said at least one attachment arm within said at least one channel a predetermined distance; and
moving said retention feature from said retracted position into said extended position after said at least one attachment arm is moved said predetermined distance relative to said at least one channel of said vehicle.

16. The method of claim 15, wherein said movement of said retention feature from said extended position to said retracted position includes compressing a spring.

17. The method of claim 15, wherein said movement of said front-end module includes concurrent movement of at least one of a fascia, a bumper, a sensor, a wire harness, and a lamp.

18. The method of claim 15, wherein said movement of said retention feature from said retracted position to said extended position upon movement of said at least one attachment arm said predetermined distance includes movement of said retention feature into an aperture formed in said channel of said vehicle.

19. The method of claim 15, further comprising elastically deforming said retention feature when said retention feature is moved from said extended position to said retracted position.

20. The method of claim 15, further comprising attaching said at least one attachment arm to said vehicle body using a mechanical fastener once said at least one attachment arm is moved said predetermined distance relative to said channel and said retention feature is moved into said extended position.
